(19) United States
(12) Patent Application Publication
(10) Pub. No.: US 2026/0245406 A1
(43) Pub. Date: Aug. 20, 2026

(54) INFORMATION PROCESSING APPARATUS, INFORMATION PROCESSING METHOD, AND NON-TRANSITORY RECORDING MEDIUM

(71) Applicant: NEC Corporation, Minato-ku, Tokyo (JP)

(72) Inventors: Yoshihiro KAJIKI, Tokyo (JP); Soichiro ARAKI, Tokyo (JP); Megumi HASHIMOTO, Tokyo (JP)

(73) Assignee: NEC Corporation, Minato-ku, Tokyo (JP)

(21) Appl. No.: 18/878,939

(22) PCT Filed: Jun. 29, 2022
(86) PCT No.: PCT/JP2022/025985

§ 371 Date: Dec. 26, 2024

(51) Int. Cl. G06V 40/40; G06V 10/75; G06V 40/16

(52) U.S. Cl. CPC G06V 40/40; G06V 10/75; G06V 40/172

(57) ABSTRACT

An information processing apparatus includes: an association unit that associates a living body with a wearing item worn by the living body; a biometric information acquisition unit that acquires biometric information collected from the living body; a wearing item identification information acquiring unit that acquires wearing item identification information capable of uniquely identifying the wearing item, from the wearing item worn by the living body; and a determination unit that determines whether the living body is wearing the wearing item associated with the living body by the association unit, based on the biometric information and the wearing item identification information.

### TECHNICAL FIELD

This disclosure relates to technical fields of an information processing apparatus, a wearable devices, an information processing methods, and a recording medium.

### BACKGROUND ART

Patent Literature 1 describes a biometric information authentication system including: a measurement device that measures biometric information of a subject; and an authentication device that communicates with the measurement device. In the biometric information authentication system described in Patent Literature 1, the measurement device determines whether or not the measurement device is being worn on the subject; and emit a light emitting unit in a predetermined light emission pattern when it is determined that the measurement device is being worn on the subject. The authentication device photographs the subject and the predetermined light emission pattern simultaneously; and authenticates the subject and the measurement device on the basis of the subject and the predetermined light emission pattern that have been photographed, re-executes light emission by the light emitting unit in response to the measurement device that is being worn again on the subject when it is determined that the measurement device has been removed from the subject during measurement of the biometric information of the subject, and re-executes authentication when a notification that the measurement device has been removed from the subject has been received from the measurement device.

Patent Literature 2 discloses various aspects directed to a wearable identity manager system. In a first aspect, an association state between a user and a wearable identity manager device is ascertained based on whether the wearable identity manager device is worn by a user, and motion data associated with a movement of the wearable identity manager device are monitored. Authentication data including the motion data are then transmitted based on the association state. In another aspect, the association state between the user and the wearable identity manager device is again determined based on whether the wearable identity manager device is worn by the user. The wearable identity manager device is paired with a pairing device, and the authentication data are transmitted to the pairing device based on the association state to facilitate user authentication via the pairing device.

Patent Literature 3 discloses a credit settlement system while making member information accumulated in a database server for electric commerce usable not only in the electric commerce but in an actual store. In the credit settlement system described in Patent Literature 3, an identification processing apparatus reads a member identification code issued from the database server for electronic commerce, and an indefinite and unique two-dimensional code attached to an identification mounting fixture. Thus, the member identification code is associated with the identification mounting fixture only within a predetermined time limit. Next, a member performs commerce by using the identification mounting fixture. At a sales floor or the like, the two-dimensional code of the identification mounting fixture and a sales information code which is issued from a register for totaling sales are read by a sales processing apparatus. The member identification code and the sales information code read by both apparatuses are associated with each other via the identification mounting fixture, and in the database server for electronic commerce, the member information and sales information are associated with each other to be stored as credit settlement information, by which credit settlement is performed.

Patent Literature 4 describes a technique/technology of preventing unauthorized use of an electronic ticket terminal. In the technique/technology described in Patent Literature 4, a storage unit stores identification information on an attachment-type electronic ticket terminal for a user to enter a restricted area and a face image obtained in advance of the user holding the attachment-type electronic ticket terminal, in association with each other. A communication unit is configured to communicate with the attachment-type electronic ticket terminal and a monitoring camera for photographing a peripheral area where the user may pass through when entering the restricted area. On receiving attachment detection information indicating detection of the attachment-type electronic ticket terminal attached to a person, together with identification information, from the attachment-type electronic ticket terminal, a face image corresponding to the stored identification information is matched with a face image extracted from an image taken by the monitoring camera.

### CITATION LIST

### Patent Literature

Patent Literature 1: International Publication No. WO2020/195300

Patent Literature 2: JP2017-520033A

Patent Literature 3: JP 2017-010121A

Patent Literature 4: JP 2015-194930A

### SUMMARY OF THE INVENTION

### Problem to be Solved by the Invention

It is an example object of this disclosure to provide an information processing apparatus, a wearable device, an information processing method, and a recording medium that aim to improve the techniques/technologies disclosed in Citation List.

### Solution to Problem

An information processing apparatus according to an example aspect includes: an association unit that associates a living body with a wearing item worn by the living body; a biometric information acquisition unit that acquires biometric information collected from the living body; a wearing item identification information acquiring unit that acquires wearing item identification information capable of uniquely identifying the wearing item, from the wearing item worn by the living body; and a determination unit that determines whether the living body is wearing the wearing item associated with the living body by the association unit, based on the biometric information and the wearing item identification information.

A wearable device according to an example aspect is a wearable device to be worn by a living body, including: a detection unit that detects that the wearable device is removed from the living body; and a first presentation unit that presents first identification information capable of uniquely identifying the wearable device in response to the wearable device being worn by the living body, ends presentation of the first identification information in response to a detection that the wearable device is removed from the living body, and presents new identification information that is different from the first identification information in response to the wearable device being worn again by the living body.

An information processing method according to an example aspect includes: associating a living body with a wearing item worn by the living body; acquiring biometric information collected from the living body; acquiring wearing item identification information capable of uniquely identifying the wearing item, from the wearing item worn by the living body; and determining whether the living body is wearing the wearing item associated with the living body, based on the biometric information and the wearing item identification information.

A recording medium according to an example aspect is a recording medium on which a computer program that allows a computer to execute an information processing method is recorded, the information processing method including: associating a living body with a wearing item worn by the living body; acquiring biometric information collected from the living body; acquiring wearing item identification information capable of uniquely identifying the wearing item, from the wearing item worn by the living body; and determining whether the living body is wearing the wearing item associated with the living body, based on the biometric information and the wearing item identification information.

### BRIEF DESCRIPTION OF DRAWINGS

FIG. 1 is a block diagram illustrating a configuration of an information processing apparatus according to a first example embodiment.

FIG. 2 is a conceptual diagram of an information processing system according to a second example embodiment.

FIG. 3 is a block diagram illustrating a configuration of the information processing system according to the second example embodiment.

FIG. 4 is a flowchart illustrating a flow of an information processing operation of an information processing apparatus according to the second example embodiment.

FIG. 5 is a block diagram illustrating a configuration of an information processing system according to a third example embodiment.

FIG. 6 is a flowchart illustrating a flow of an information processing operation of an information processing apparatus according to the third example embodiment.

FIG. 7 is a block diagram illustrating a configuration of an information processing system according to a fourth example embodiment.

FIG. 8 is a flowchart illustrating a flow of an information processing operation of an information processing apparatus according to the fourth example embodiment.

FIG. 9 is a block diagram illustrating a configuration of an information processing system according to a fifth example embodiment.

FIG. 10 is a flowchart illustrating a flow of an information processing operation of an information processing apparatus according to the fifth example embodiment.

FIG. 11 is a conceptual diagram of an information processing system according to a sixth example embodiment.

FIG. 12 is a block diagram illustrating a configuration of the information processing system according to the sixth example embodiment.

FIG. 13 is a flowchart illustrating a flow of an information processing operation of an information processing apparatus according to the sixth example embodiment.

FIG. 14 is a conceptual diagram of an information processing system according to a seventh example embodiment.

FIG. 15 is a block diagram illustrating a configuration of the information processing system according to the seventh example embodiment.

FIG. 16 is a block diagram illustrating a configuration of an information processing system according to an eighth example embodiment.

FIG. 17 is a block diagram illustrating a configuration of an information processing system according to a ninth example embodiment.

FIG. 18 is a block diagram illustrating a configuration of an information processing system according to a tenth example embodiment.

### DESCRIPTION OF EXAMPLE EMBODIMENTS

Hereinafter, an information processing apparatus, a wearable device, an information processing method, and a recording medium according to example embodiments will be described with reference to the drawings.

### 1: First Example Embodiment

An information processing apparatus, a wearable device, an information processing method, and a recording medium according to a first example embodiment will be described. The following describes the information processing apparatus, the wearable device, the information processing method, and the recording medium according to the first example embodiment, by using an information processing apparatus 10 to which the information processing apparatus, the wearable device, the information processing method, and the recording medium according to the first example embodiment are applied.

### [1-1: Configuration of Information Processing Apparatus 10]

FIG. 1 is a block diagram illustrating a configuration of the information processing apparatus 10 according to the first example embodiment. As illustrated in FIG. 1, the information processing apparatus 10 includes an association unit 11, a biometric information acquisition unit 12, a wearing item identification information acquisition unit 13, and a determination unit 14.

The association unit 11 associates a living body with a wearing item worn by the living body. The biometric information acquisition unit 12 acquires biometric information collected from the living body. The wearing item identification information acquisition unit 13 acquires wearing item identification information capable of uniquely identifying the wearing item worn by the living body, from the wearing item. The determination unit 14 determines whether the living body is wearing the wearing item associated with the living body by the association unit 11, based on the biometric information and the wearing item identification information.

### [1-2: Technical Effect of Information Processing Apparatus 10]

Since the information processing apparatus 10 according to the first example embodiment determines whether the living body is wearing the wearing item associated with the living body by the association unit 11, it is possible to ensure that the living body and the wearing item are certainly associated with each other. Since the determination unit 14 makes the determination, it is possible to prevent that the living body is switched to a person other than the corresponding living body, and the person wears the wearing item to impersonate the corresponding living body.

### 2: Second Example Embodiment

An information processing apparatus, a wearable device, an information processing method, and a recording medium according to a second example embodiment will be described. The following describes the information processing apparatus, the wearable device, the information processing method, and the recording medium according to the second example embodiment, by using an information processing system S2 to which the information processing apparatus, the wearable device, the information processing method, and the recording medium according to the second example embodiment are applied.

The information processing system S2 according to the second example embodiment may be applied to, for example, authentication of a worker in a factory. In particular, it may be applied to authentication when it is hard to collect the biometric information, such as in an operation of crawling under a car. It may also be applied to authentication of a person in an office. In particular, it may be applied to authentication of a person in a case of handling confidential information that requires strict authentication. Furthermore, for example, it may be applied to authentication of a person who is permitted to use a specific service. Alternatively, the information processing system S2 may be applied to authentication of a person who is temporarily permitted to take actions in a specific area such as, for example, a theme park.

[2-1: Overall Configuration of Information processing System S2]

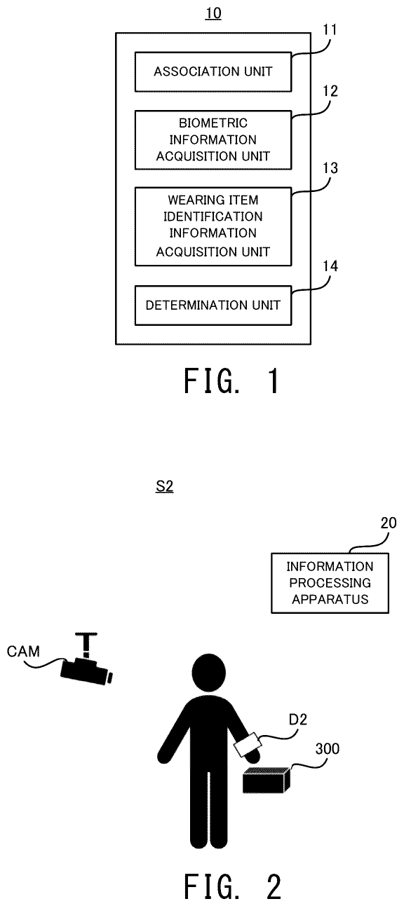

FIG. 2 is a conceptual diagram of the information processing system S2 according to the second example embodiment. As illustrated in FIG. 2, the information processing system S2 according to the second example embodiment may include an information processing apparatus 20, a wearable device D2, a device reading apparatus 300, and a camera CAM. The wearable device D2 may be worn by an authentication subject that is a living body. The device reading apparatus 300 may read the wearing item identification information capable of uniquely identifying the wearable device D2 worn by the authentication subject, from the wearable device D2. The camera CAM may image the authentication subject wearing the wearable device D2. The information processing apparatus 20 may acquire an image from the camera CAM, may acquire the wearing item identification information from the device reading apparatus 300, and may associate the authentication subject with the wearable device D2.

### [Wearable Device D2]

In the second example embodiment, the wearable device D2 serving as the wearing item includes a first presentation unit D21 that presents the wearing item identification information capable of uniquely identifying the wearable device D2. The first presentation unit D21 may present the wearing item identification information capable of uniquely identifying the wearable device D2, by radio waves. Furthermore, the first presentation unit D21 may present the wearing item identification information only to an authenticated device. The wearable device D2 may be a RF tag worn by the authentication subject. The RF tag may include those of various standards such as RFID and NFC.

The wearable device D2 may be a passive RF tag. The passive RF tag is an electronic circuit without a built-in power supply, passively storing an ID by obtaining power from radio waves emitted by a reader and a writer, and passively transmitting the ID by obtaining the power from the radio waves emitted by the reader and the writer. When the wearable device D2 is the passive RF tag, the wearable device D2 may not perform information processing on its own, and may not perform intelligent operations, such as stopping the transmission of the wearing item identification information and disabling the wearing item identification information.

The wearable device D2 may be an active RF tag. The active RF tag is an electronic circuit with a built-in power supply, actively transmitting the ID to a surrounding area by radio waves. When the wearable device D2 is the active RF tag, the wearable device D2 may perform information processing on its own, and may perform intelligent operations, such as stopping the transmission of the wearing item identification information and disabling the wearing item identification information, depending on its own condition.

The wearable device D2 may also be a device such as a smartphone equipped with a wireless communication function of presenting the wearing item identification information by radio waves. The wearable device D2 may also include a radio beacon capable of presenting position information.

### [Device Reading Apparatus 300]

The device reading apparatus 300 may be an authenticated and certified device to which the wearing item identification information is presented by the wearable device D2. The wearable device D2 and the device reading apparatus 300 may perform authentication operations on each other.

The device reading apparatus 300 may write the wearing item identification information onto the wearable device D2. Conversely, a third party other than the device reading apparatus 300 is not allowed to write the wearing item identification information onto the wearable device D2. The device reading apparatus 300 may register the written wearing item identification information in a storage medium. The device reading apparatus 300 may perform authentication, by calculating a perfect match between the registered wearing item identification information and the read wearing item identification information. In this instance, the device reading apparatus 300 allows instant authentication, and thus does not make the authentication subject wait. Furthermore, in this case, the device reading apparatus 300 is allowed to perform the authentication by using an inexpensive embedded CPU.

In addition, the device reading apparatus 300 may not be capable of reading the ID of a falsified device, from the device. In this instance, the falsified device is not authenticated by the device reading apparatus 300. In addition, a third party is not able to read the wearing item identification information from the wearable device D2. This prevents spoofing of the wearable device D2 and ensures genuineness/authenticity of the wearable device D2.

When the wearable device D2 is the passive RF tag, the authentication subject may hold the wearable device D2 over the device reading apparatus 300 to cause the device reading apparatus 300 to read the wearing item identification information.

When the wearable device D2 is the active RF tag, the device reading apparatus 300 may receive radio waves emitted by the wearable device D2, for example, from a location 10 meters or more away from the wearable device D2. In this instance, the authentication subject does not need to hold the wearable device D2 over the device reading apparatus 300. In addition, when the wearable device D2 is the active RF tag, the device reading apparatus 300 may measure a radio wave transmitting position by the wearable device D2.

The configuration illustrated in FIG. 2 is an example. An apparatus other than the apparatuses illustrated in FIG. 2 may be added, and a part of the apparatuses may not be provided. Furthermore, a part of the apparatuses may be replaced by another apparatus having a similar function. In addition, a part of the functions in present example embodiment may be provided by another apparatus via a network. The functions in the present example embodiment may be distributed and realized in a plurality of apparatuses. Alternatively, for example, the information processing apparatus 20 may have the function of the device reading apparatus 300. Alternatively, the information processing apparatus 20 may be equipped with the camera CAM. The configuration included in the information processing system S2 except the wearable device D2, may be integrated or separated.

### [2-2: Configuration of Information Processing Apparatus 20]

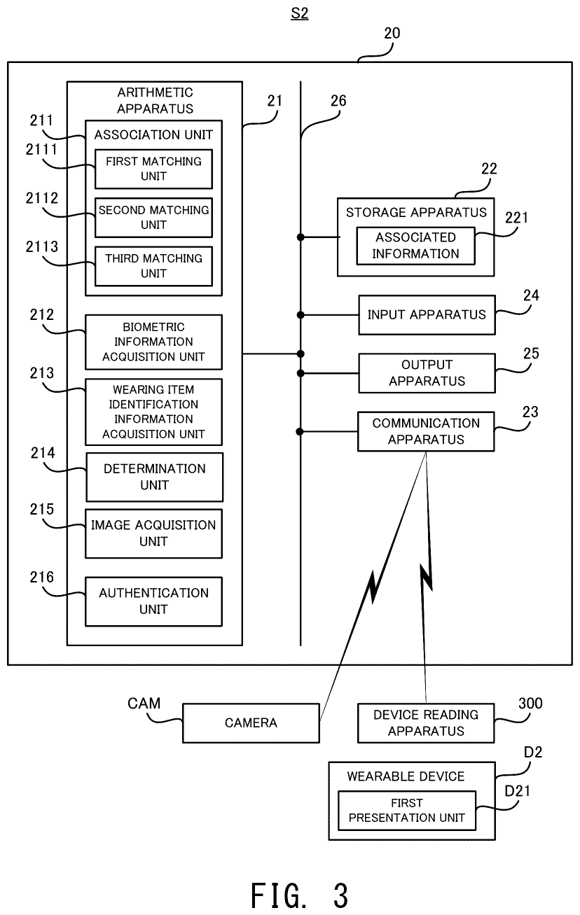

FIG. 3 is a block diagram of the information processing apparatus 20 according to the second example embodiment. As illustrated in FIG. 3, the information processing apparatus 20 includes an arithmetic apparatus 21 and a storage apparatus 22. Furthermore, the information processing apparatus 20 may include a communication apparatus 23, an input apparatus 24, and an output apparatus 25. The information processing apparatus 20, however, may not include at least one of the communication apparatus 23, the input apparatus 24, and the output apparatus 25. The arithmetic apparatus 21, the storage apparatus 22, the communication apparatus 23, the input apparatus 24, and the output apparatus 25 may be connected via a data bus 26.

The arithmetic apparatus 21 includes at least one of a CPU (Central Processing Unit), a GPU (Graphics Processing Unit), and a FPGA (Field Programmable Gate Array), for example. The arithmetic apparatus 21 reads a computer program. For example, the arithmetic apparatus 21 may read a computer program stored in the storage apparatus 22. For example, the arithmetic apparatus 21 may read a computer program stored by a computer-readable and non-transitory recording medium, by using a not-illustrated recording medium reading apparatus provided in the information processing apparatus 20 (e.g., the input apparatus 24 described later). The arithmetic apparatus 21 may acquire (i.e., download or read) a computer program from a not-illustrated apparatus disposed outside the information processing apparatus 20 via the communication apparatus 23 (or another communication apparatus). The arithmetic apparatus 21 executes the read computer program. Consequently, a logical functional block for performing an operation to be performed by the information processing apparatus 20 is realized or implemented in the arithmetic apparatus 21. That is, the arithmetic apparatus 21 is allowed to function as a controller for realizing or implementing the logical functional block for performing an operation (in other words, processing) to be performed by the information processing apparatus 20.

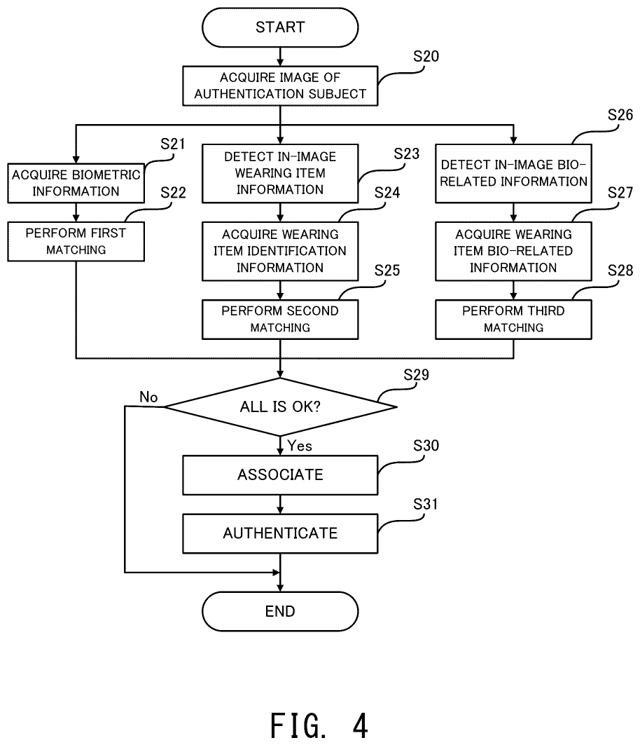

FIG. 3 illustrates an example of the logical functional block realized or implemented in the arithmetic apparatus 21 to perform an information processing operation. As illustrated in FIG. 3, an association unit 211 that is a specific example of the “association unit” described in Supplementary Note later, a biometric information acquisition unit 212 that is a specific example of the “biometric information acquisition unit” described in Supplementary Note later, a wearing item identification information acquisition unit 213 that is a specific example of the “wearing item identification information acquisition unit” described in Supplementary Note later, a determination unit 214 that is a specific example of the “determination unit” described in Supplementary Note later, an image acquisition unit 215 that is a specific example of the “image acquisition unit” described in Supplementary Note later, and an authentication unit 216 that is a specific example of the “authentication unit” described in Supplementary Note later, are realized or implemented in the arithmetic apparatus 21. The arithmetic apparatus 21, however, may not include at least one of the image acquisition unit 215 and the authentication unit 216. Detailed operation of each of the association unit 211, the biometric information acquisition unit 212, the wearing item identification information acquisition unit 213, the determination unit 214, the image acquisition unit 215, and the authentication unit 216 will be described in detail later with reference to FIG. 4.

The storage apparatus 22 is configured to store desired data. For example, the storage apparatus 22 may temporarily store a computer program to be executed by the arithmetic apparatus 21. The storage apparatus 22 may temporarily store data that are temporarily used by the arithmetic apparatus 21 when the arithmetic apparatus 21 executes the computer program. The storage apparatus 22 may store data that are stored by the information processing apparatus 20 for a long time. The storage apparatus 22 may include at least one of a RAM (Random Access Memory), a ROM (Read Only Memory), a hard disk apparatus, a magneto-optical disk apparatus, a SSD (Solid State Drive), and a disk array apparatus. That is, the storage apparatus 22 may include a non-transitory recording medium.

The communication apparatus 23 is configured to communicate with an apparatus external to the information processing apparatus 20 via a not-illustrated communication network. The information processing apparatus 20 may transmit and receive signals to and from the device reading apparatus 300 and the camera CAM via the communication apparatus 23.

The input apparatus 24 is an apparatus that receives input of information to the information processing apparatus 20 from an outside of the information processing apparatus 20. For example, the input apparatus 24 may include an operating apparatus (e.g., at least one of a keyboard, a mouse, and a touch panel) that is operable by an operator of the information processing apparatus 20. For example, the input apparatus 24 may include a reading apparatus that is configured to read information recorded as data on a recording medium that is externally attachable to the information processing apparatus 20.

The output apparatus 25 is an apparatus that outputs information to the outside of the information processing apparatus 20. For example, the output apparatus 25 may output the information as an image. That is, the output apparatus 25 may include a display apparatus (a so-called display) that is configured to display an image indicating the information that is desirably outputted. For example, the output apparatus 25 may output information as audio/sound. That is, the output apparatus 25 may include an audio apparatus (a so-called speaker) that is configured to output audio/sound. For example, the output apparatus 25 may output information onto a paper surface. That is, the output apparatus 25 may include a print apparatus (a so-called printer) that is configured to print desired information on the paper surface.

### [2-3: Information Processing Operation Performed by Information Processing Apparatus 20]

Next, an information processing operation performed by the information processing apparatus 20 according to the second example embodiment will be described with reference to FIG. 4. FIG. 4 is a diagram illustrating a flow of the information processing operation performed by the information processing apparatus 20 according to the second example embodiment.

As illustrated in FIG. 4, the image acquisition unit 215 acquires an image of the authentication subject wearing the wearable device D2 (step S20). The image acquisition unit 215 may acquire the image captured by the camera CAM, via the communication apparatus 23. The image acquired by the image acquisition unit 215 may be an image including at least a part of the authentication subject from which the biometric information is collected, and a part of the authentication subject writing the wearable device D2.

The biometric information acquisition unit 212 acquires the biometric information collected from the authentication subject (step S21). The biometric information acquisition unit 212 may acquire the biometric information collected from the authentication subject wearing the wearable device D2. The biometric information acquisition unit 212 may acquire the biometric information collected from the authentication subject when the authentication subject puts on the wearable device D2. Alternatively, the biometric information acquisition unit 212 may acquire the biometric information collected from the authentication subject before the authentication subject puts on the wearable device D2. The biometric information acquisition unit 212 may acquire, as the biometric information, a face image or an iris image of the authentication subject included in the image acquired by the image acquisition unit 215, for example.

A first matching unit 2111 performs first matching using the biometric information (step S22). The first matching unit 2111 may perform biometric authentication by using an image of the authentication subject wearing the wearable device D2, as the first matching. The first matching unit 2111 may perform face authentication using the face image, or iris authentication using the iris image, for example. The first matching unit 2111 may determine that identity of the authentication subject is matched when the first matching is successful.

A second matching unit 2112 detects in-image wearing item information about the wearable device D2 included in the image (step S23). The in-image wearing item information may be information presented by the wearable device D2 captured in the image. The in-image wearing item information may be information capable of uniquely identifying the wearable device D2.

The wearing item identification information acquisition unit 213 acquires the wearing item identification information capable of uniquely identifying the wearable device D2, from the wearable device D2 worn by the authentication subject (step S24). The wearing item identification information acquisition unit 213 may acquire, from the device reading apparatus 300, the wearing item identification information read by the device reading apparatus 300 from the wearable device D2.

The second matching unit 2112 performs second matching using the in-image wearing item information and the wearing item identification information (step S25). The second matching unit 2112 may confirm whether the wearable device D2 in the image corresponds to the wearable device D2 presenting the wearing item identification information. The second matching unit 2112 may determine that the wearing item identification information is reliable identification information, based on the fact that pieces of identification information acquired in different acquisition methods and by different acquisition routes correspond to each other. When the second matching is successful, the second matching unit 2112 may determine that the wearing item identification information acquired by the wearing item identification information acquisition unit 213 is identification information capable of uniquely identifying the wearable device D2 worn by the living body.

A third matching unit 2113 detects in-image bio-related information about the authentication subject included in the image (step S26). The in-image bio-related information may include information about a part of the authentication subject from which the biometric information is collected.

The third matching unit 2113 detects wearing item bio-related information about the wearing item worn by the authentication subject (step S27). The wearing item bio-related information may be information about both a body of the authentication subject and the wearable device D2. The wearing item bio-related information may be information presented by the wearable device D2. The third matching unit 2113 performs third matching using the in-image bio-related information and the wearing item bio-related information (step S28). When the third matching is successful, the third matching unit 2113 may ensure that the wearable device D2 is certainly worn by the authentication subject.

The association unit 211 determines whether or not all the first matching, the second matching, and the third matching are successful (step S29). When all the matchings are successful (the step S29: Yes), the association unit 211 associates the authentication subject with the wearable device D2 worn by the authentication subject (step S30). That is, the association unit 211 associates the authentication subject with the wearable device D2 worn by the authentication subject, based on the first matching performed by the first matching unit 2111, the second matching performed by the second matching unit 2112, and the third matching performed by the third matching unit 2113.

The association unit 211 may determine that the wearing item identification information presented by the wearable device D2 is information as reliable as the biometric information on the authentication subject, based on the fact that the identity of the authentication subject is matched, that the wearing item identification information presented by the wearable device D2 is reliable identification information, and that the wearable device D2 is certainly worn by the authentication subject. The association unit 211 may associate the biometric information collected from the authentication subject with the wearing item identification information capable of uniquely identifying the wearable device D2, and may store, in the storage authentication 22, associated information 221 in which the biometric information is associated with the wearing item identification information. The information processing apparatus 20 may manage the association of the authentication subject with the wearable device D2, by means of the associated information 221.

When the association unit 211 associates the authentication subject with the wearable device D2, the authentication unit 216 authenticate the authentication subject, by using the wearing item identification information (step S31). After completion of the association by the association unit 211, the authentication unit 216 may perform authentication using the wearing item identification information presented by the wearable device D2 being worn, as a substitute for the biometric authentication. That is, when the association unit 211 ensures the identity of the wearable device D2 worn by the authentication subject, the authentication unit 216 may authenticate the authentication subject by using the wearing item identification information.

For example, the operation in the step S20 to the step S30 may be an authentication operation before starting work, which is performed at an entrance to a specific area such as an office and a factory. The authentication subject may put on the wearable device D2 prior to the authentication operation before starting work. The association unit 211 may associate the authenticated subject with the wearable device D2.

After the association by the association unit 211, the authentication unit 216 may perform personal belonging authentication using the wearing item identification information about the wearable device D2 received by the device reading apparatus 300, as a substitute for the biometric authentication. Furthermore, the information processing apparatus 20 may record actions of the authentication subject in a specific area such as an office and a factory, based on the wearing item identification information received by the device reading apparatus 300.

In the second example embodiment, the determination unit 214 may determine whether the authentication subject is wearing the wearable device D2 associated with the authentication subject by the association unit 211, based on an operation the same as at least one of the first matching, the second matching, and the third matching in the association unit 211. The determination unit 214 may perform the operation when or after the association unit 211 associates the living body with the wearable device D2. The determination unit 214 may perform an operation of confirming that the association is maintained. For example, when the authentication subject wears the wearable device D2 for a long period of time, the determination unit 214 may regularly/periodically determine whether a combination of the authentication subject and the wearable device D2 is changed. Even when the combination of the authentication subject and the wearable device D2 is not changed, in a case of a corruption of information included in the wearable device D2 such as a failure of the wearable device D2 or in similar cases, the wearable device D2 may be no longer capable of performing an expected operation, and the wearable device D2 may no longer ensure the authentication of the authentication subject. As described above, even in a case where replacement with a new device is necessary, the operation of the determination unit 214 is useful.

The association unit 211 and the determination unit 214 are capable of verifying the association between the living body and the wearable device D2, in a state in which the living body wears the wearable device D2. The operation performed by the association unit 211 and the determining unit 214 eliminates a risk of spoofing, even when there are a plurality of people in the vicinity of the device reading apparatus 300.

Although the second example embodiment exemplifies the face authentication and the iris authentication as the first matching in the step S22, the first matching may be fingerprint authentication, palmprint authentication, vein authentication, otoacoustic or ear acoustic authentication, or the like.

### [2-4: Technical Effect of Information Processing Apparatus 20]

The information processing apparatus 20 according to the second example embodiment is capable of ensuring the identity between the authentication subject and the wearable device D2. Since the information processing apparatus 20 associates the biometric information collected from the authentication subject with the wearing item identification information capable of uniquely identifying the wearable device D2, it is possible to use the wearing item identification information presented by the wearable device D2, as information as reliable as the biometric information on the authentication subject.

For example, in inspection of finished products in a factory, it is legally obligated to record the inspection by a specially qualified worker. For example, it is considered that a worker's signature on books and documents is used as an inspection record, but forgery of the books and documents is also possible. The biometric authentication such as face authentication and iris authentication, is useful for the record that is hardly falsified, and allows recording of trail/evidence of the presence of a particular person at a given location. There is, however, a trade-off relation between accuracy of the biometric authentication and a burden on the authentication subject. For example, in performing accurate biometric authentication such as face authentication and iris authentication, the authentication subject needs to face a camera for several seconds or take similar actions, which requires a heavy burden on the authentication subject. On the other hand, when the burden on the authentication subject is reduced by shortening the time for the authentication subject to face the camera, authentication accuracy may deteriorate and false authentication may occur.

In addition, the accurate biometric authentication is accompanied with an operation interfering with the work of the authentication subject in some cases. Therefore, if the biometric authentication is imposed for each inspection of individual finished products, work efficiency may be reduced, and it is thus often hard to apply the biometric authentication.

Furthermore, for example, in an office where confidential information is handled, strict authentication is required, even in accessing cabinets, multifunction devices, or the like. The biometric authentication is useful as the strict authentication, but if the biometric authentication is obligated for each access in a business operation of accessing various pieces of confidential information, business efficiency may be reduced, and it is thus often hard to apply the biometric authentication.

Furthermore, for example, in an event or the like in which hundreds or thousands or people enter and leave at a time, if all individuals are identified by the biometric authentication, it may hinder human motion/movement. The installation of biometric authentication apparatuses in a variety of devices and locations provides a heavy cost burden. As described above, there is a demand for person authentication having the same accuracy as that of the accurate biometric authentication without interfering with the human motion.

In contrast, the information processing system S2 according to the second example embodiment is capable of ensuring the identity between the authentication subject and the wearable device D2, and is capable of using the wearing item identification information presented by the wearable device D2 as information as reliable as the biometric information on the authentication subject. It is therefore possible to realize the person authentication having the same accuracy as that of the accurate biometric authentication without interfering with the human motion/action.

Since the biometric information such as a fingerprint image, a face image, and an iris image, varies for each individual, it is possible to ensure uniqueness with sufficient accuracy. That is, the biometric information allows genuineness/authenticity to be ensured. According to the present example embodiment, the authentication based on the biometric authentication on the authentication subject himself is realized. Therefore, the spoofing by a third party is extremely hard, and it is possible to ensure the genuineness/authenticity of the authentication subject.

The present example embodiment allows realization of both benefits of the biometric authentication and ensured uniqueness. Since the biometric authentication having extremely high authentication accuracy is linked to the personal belonging authentication using the wearable device D2 and having a less burden of the authentication subject, it is possible to realize highly accurate and convenient identity authentication even in situations where it is hard to apply the biometric authentication.

### 3: Third Example Embodiment

An information processing apparatus, a wearable device, an information processing method, and a recording medium according to a third example embodiment will be described. The following describes the information processing apparatus, the wearable device, the information processing method, and the recording medium according to the third example embodiment, by using an information processing system S3 to which the information processing apparatus, the wearable device, the information processing method, and the recording medium according to the third example embodiment are applied.

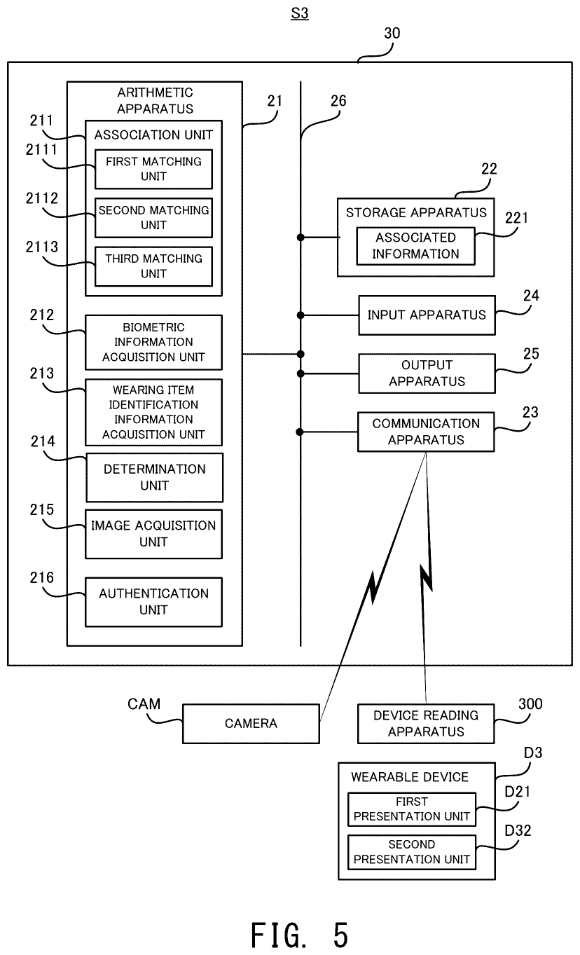

With reference to FIG. 5, a configuration of the information processing system S3 according to the third example embodiment will be described. FIG. 5 is a block diagram illustrating the configuration of the information processing system S3 according to the third example embodiment.

As illustrated in FIG. 5, the information processing system S3 according to the third example embodiment is different from the information processing system S2 according to the second example embodiment in that it includes a wearable device D3 in place of the wearable device D2. The wearable device D3 is different from the wearable device D2 in that it further includes a second presentation unit D32. The second presentation unit D32 presents the in-image wearing item information, as second identification information capable of uniquely identifying the wearable device D3 and capable of appearing in the image. That is, the wearable device D3 presents the wearing item identification information by radio waves or the like, and also presents the in-image wearing item information uniquely corresponding to the wearing item identification information. Other features of the information processing system S3 may be the same as those of the information processing system S2. For this reason, a part that is different from each of the example embodiments described above will be described in detail below, and a description of the other overlapping parts will be omitted as appropriate.

The wearable device D3 may be provided with a function of presenting a unique ID capable of appearing in the image, as the second presentation unit D32, when the device reading apparatus 300 writes the wearing item identification information. The device reading apparatus 300 not only writes the wearing item identification information onto an electronic circuit of the wearable device D3, but also may print the in-image wearing item identification information, such as, for example, characters, a one-dimensional code like a bar code, and a matrix-type two-dimensional code, on the surface of the wearable device D3. An apparatus different from the device reading apparatus 300 may print the in-image wearing item identification information on the surface of the wearable device D3. A user of the information processing S3 may attach a printed matter of the in-image wearing item identification information to the surface of the wearable device D3.

### [3-1: Information Processing Operation Performed by Information Processing Apparatus 30]

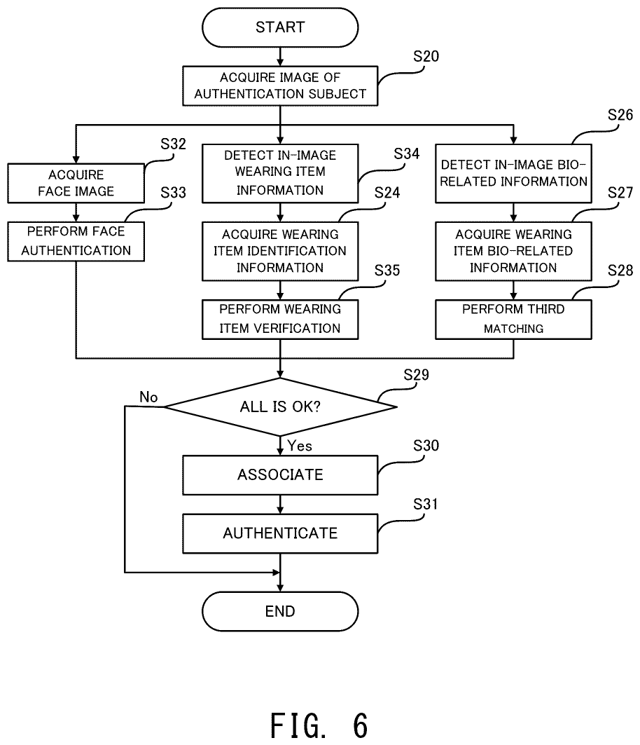

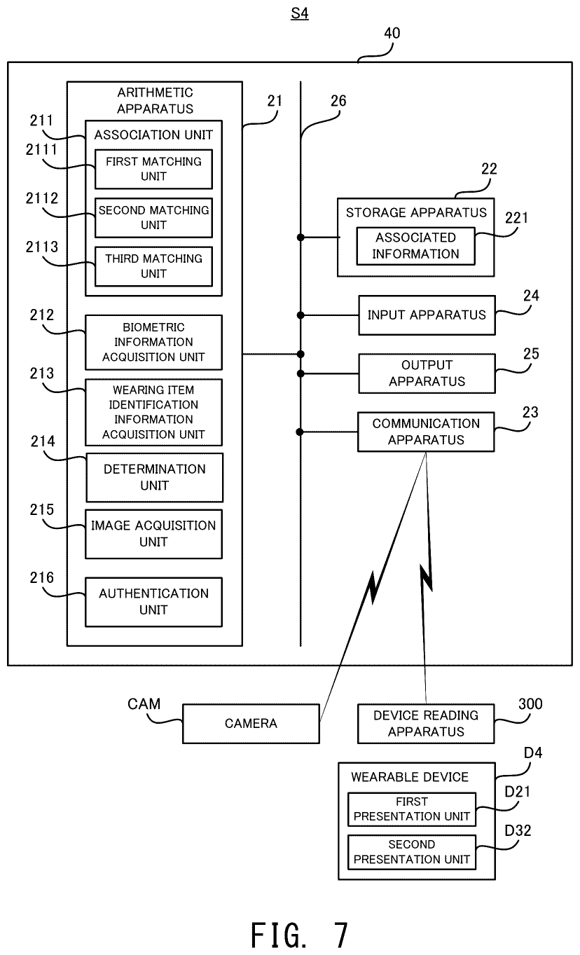

With reference to FIG. 6, an information processing operation performed by an information processing apparatus 30 according to the third example embodiment will be described. FIG. 6 is a diagram illustrating a flow of the information processing operation performed by the information processing apparatus 30 according to the third example embodiment.

As illustrated in FIG. 6, the image acquisition unit 215 acquires an image of the authentication subject wearing the wearable device D3 (step S20).

The biometric information acquisition unit 212 acquires the face image as the biometric information from the image acquired in the step S20 (step S32). The first matching unit 2111 performs the face authentication for the authentication subject using the face image of the authentication subject acquired in the step S32 (step S33).

The second matching unit 2112 detects the in-image wearing item identification information presented by the second presentation unit D32 and capable of uniquely identifying the wearable device D3 captured in the image acquired in the step S20 (step S34). The in-image wearing item identification information may be, for example, characters, a one-dimensional code such as a bar code, and a matrix-type two-dimensional code, which are presented by the second presentation unit D32. The in-image wearing item identification information may be, for example, a light blinking signal capable of uniquely identifying the wearable device D3 and presented by the second presentation unit D32. In this instance, the image acquired by image acquisition unit 215 may be a moving image.

The wearing item identification information acquisition unit 213 acquires the wearing item identification information capable of uniquely identifying the wearable device D3, from the wearable device D3 worn by the authentication subject (step S24). The wearing item identification information acquisition unit 213 may acquire the wearing item identification information presented by the first presentation unit D21, which is read by the device reading apparatus 300, from the device reading apparatus 300 via the communication apparatus 23.

The second matching unit 2112 performs wearing item matching, as the second matching using the in-image wearing item information and the wearing item identification information (step S35). The second matching unit 2112 may match the wearable device D3 identified by the in-image wearing item identification information, with the wearable device D3 identified by the wearing item identification information. That is, the second matching unit 2112 may determine whether or not the wearable device D3 presenting the information captured in the image acquired by the image acquisition unit 215 is the same as the wearable device D3 outputting the wearing item identification information acquired by the wearing item identification information acquisition unit 213.

The third matching unit 2113 detects the in-image bio-related information about the authentication subject included in the image (step S26). The third matching part 2113 detects the wearing item bio-related information about the wearing item worn by the authentication subject (step S27). The third matching unit 2113 performs the third matching using the in-image bio-related information and the wearing item bio-related information (step S28).

The association unit 211 determines whether or not all the face authentication, the wearing item matching, and the third matching are successful (step S29). When all the matchings are successful (the step S29: Yes), the association unit 211 associates the authentication subject with the wearable device D3 worn by the authentication subject, based on the face authentication performed by the first matching unit 2111, the wearing item matching performed by the second matching unit 2112, and the third matching performed by the third matching unit 2113 (step S30). When the association unit 211 associates the authentication subject with the wearable device D3, the authentication unit 216 authenticates the authentication subject by using the wearing item identification information (step S31).

In the third example embodiment, the face authentication using the face image is performed in the step S33, but instead of the face authentication, the iris authentication using the iris image, which is the biometric authentication using the image, may be also performed.

[3-2: Technical Effect of Information processing Apparatus 30]

In the information processing system S3 according to the third example embodiment, not only the wearable device D3 presents the unique ID by radio waves or the like, but also the wearable device D3 presents the information uniquely corresponding to the unique ID, in a manner capable of appearing in the image, such as characters, a one-dimensional code like a bar code, a matrix-type two-dimensional code, and light blinking. In this way, the in-image wearing item identification information appears in the image with the authentication subject, and it is thus possible to verify the association between the authentication subject and the wearable device D3 from the image. The information processing system S3 is capable of ensuring the identity of the wearable device D3 when it is worn by the authentication subject.

### 4: Fourth Example Embodiment

An information processing apparatus, a wearable device, an information processing method, and a recording medium according to a fourth example embodiment will be described. The following describes the information processing apparatus, the wearable device, the information processing method, and the recording medium according to the fourth example embodiment, by using an information processing system S4 to which the information processing apparatus, the wearable device, the information processing method, and the recording medium according to the fourth example embodiment are applied.

The information processing system S4 according to the fourth example embodiment is different from the information processing system S3 according to the third example embodiment, in the operation of the third matching unit 2113. Other features of the information processing system S4 may be the same as those of the information processing system S3. For this reason, a part that is different from each of the example embodiments described above will be described in detail below, and a description of the other overlapping parts will be omitted as appropriate.

### [4-1: Information Processing Operation Performed by Information Processing Apparatus 40]

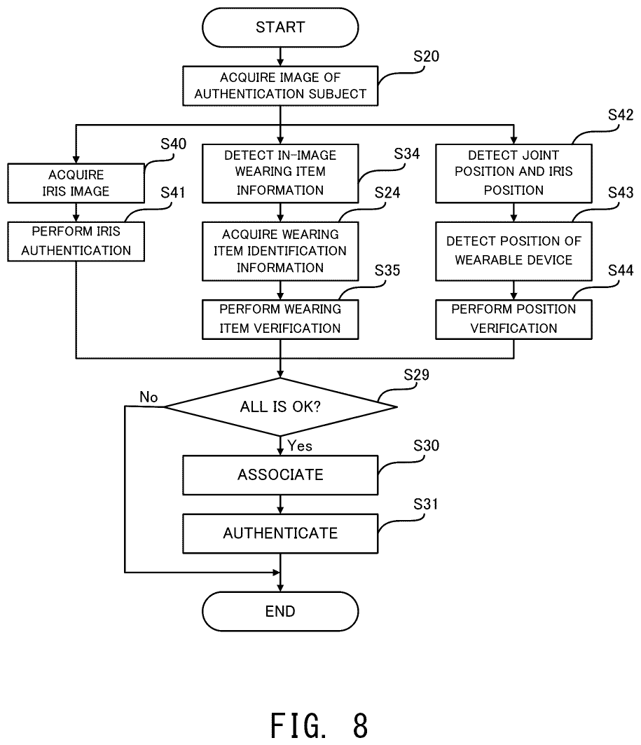

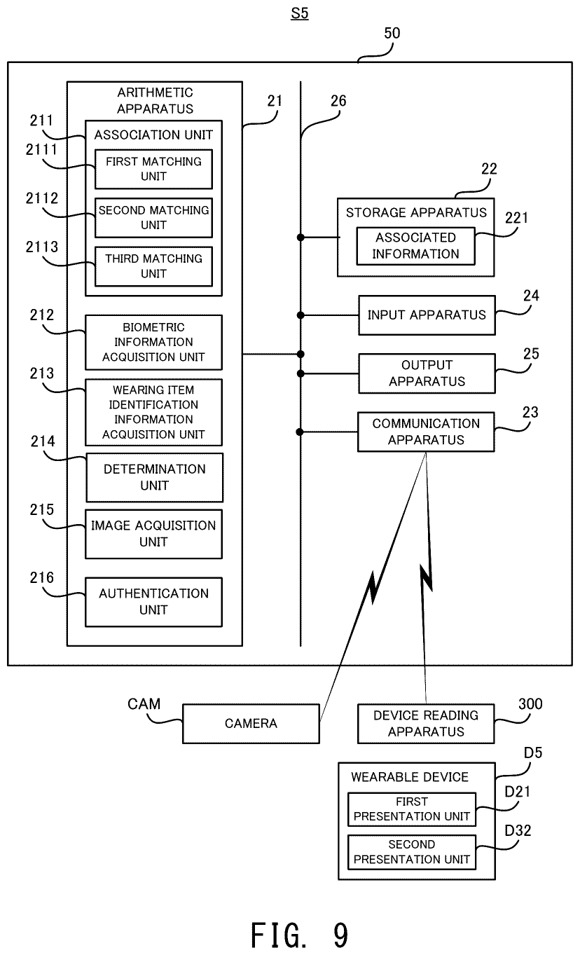

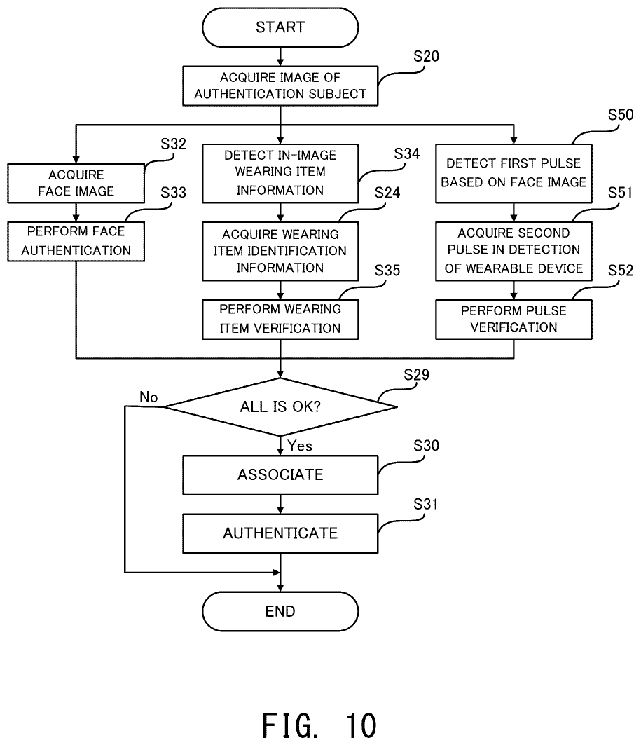

Next, with reference to FIG. 8, an information processing operation performed by an information processing apparatus 40 according to the fourth example embodiment will be described. FIG. 8 is a diagram illustrating a flow of the information processing operation performed by the information processing apparatus 40 according to the fourth example embodiment.

As illustrated in FIG. 8, the image acquisition unit 215 acquires an image of the authentication subject wearing a wearable device D4 (step S20).

The biometric information acquisition unit 212 acquires the iris image as the biometric information from the image acquired in the step S20 (step S40). The first matching unit 2111 performs the iris authentication for the authentication subject using the iris image of the authentication subject acquired in the step S40 (step S41).

The second matching unit 2112 detects the in-image wearing item identification information presented by the wearable device D4 and capable of uniquely identifying the wearable device D4 captured in the image acquired in the step S20 (step S34). The wearing item identification information acquisition unit 213 acquires the wearing item identification information capable of uniquely identifying the wearable device D4, from the wearable device D4 worn by the authentication subject (step S24). The second matching unit 2112 performs the wearing item matching, as the second matching using the in-image wearing item information and the wearing item identification information (step S35).

The third matching unit 2113 detects joint position information indicating a position of a predetermined joint of the authentication subject included in the image, and collection position information indicating a position of collection of the iris image serving as the biometric information, of the authentication subject included in the image (step S42). The third matching unit 2113 detects wearing position information indicating a wearing position of the wearable device D4, of the authentication subject included in the image (step S43). The position at which the wearable device D4 is worn by the authentication subject included in the image, may be a position of the in-image wearing item identification information presented by the wearable device D4 detected in the step S34.

The third matching unit 2113 performs position verification using the joint position information, the collection position information, and the wearing position information (step S44). The third matching unit 2113 may verify, for example, whether the joint position information, the collection position information, and the wearing position information are in a natural positional relation. The third matching unit 2113 may detect a predetermined joint position of the authentication subject from the same image, and may compare the position of a part subjected to the biometric authentication with the position of the wearable device D4, thereby verifying that a person performing the biometric authentication and a person wearing the wearable device D4 are the same person.

The association unit 211 determines whether or not all the iris authentication, the wearing item matching, and the position verification are successful (step S29). When all the matchings are successful (the step S29: Yes), the association unit 211 associates the authentication subject with the wearable device D4 worn by the authentication subject, based on the iris authentication performed by the first authentication unit 2111, the wearing item matching performed by the second matching unit 2112, and the position verification performed by the third matching unit 2113 (step S30). When the association unit 211 associates the authentication subject with the wearable device D4, the authentication unit 216 authenticates the authentication subject by using the wearing item identification information (step S31).

In the fourth example embodiment, the iris authentication using the iris image is performed in the step S41, but instead of the iris authentication, the face authentication using the face image, which is the biometric authentication using the image, may be also performed.

### [4-2: Technical Effect of Information Processing Apparatus 40]

The information processing system S4 according to the fourth example embodiment is capable of verifying that a person performing the biometric authentication and a person wearing the wearable device D4 are the same person, based on the predetermined joint position of the authentication subject, the position of a part subject to the biometric authentication, and the position of the wearable device D4, which are included in the image.

### 5: Fifth Example Embodiment

An information processing apparatus, a wearable device, an information processing method, and a recording medium according to a fifth example embodiment will be described. The following describes the information processing apparatus, the wearable device, the information processing method, and the recording medium according to the fifth example embodiment, by using an information processing system S5 to which the information processing apparatus, the wearable device, the information processing method, and the recording medium according to the fifth example embodiment are applied.

The information processing system S5 according to the fifth example embodiment is different from the information processing system S3 according to the third example embodiment and the information processing system S4 according to the fourth example embodiment, in the operation of the third matching unit 2113. In the fifth example embodiment, a wearable device D5 may be a device capable of measuring a pulse, such as a smartwatch. Other features of the information processing system S5 may be the same as those of the information processing system S3 or the information processing system S4. For this reason, a part that is different from each of the example embodiments described above will be described in detail below, and a description of the other overlapping parts will be omitted as appropriate.

### [5-1: Information Processing Operation Performed by Information Processing Apparatus 50]

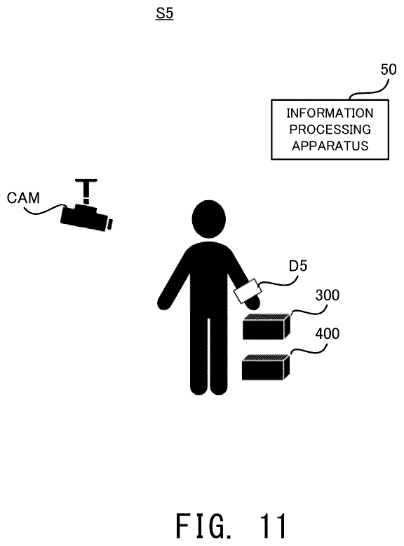

Next, with reference to FIG. 10, an information processing operation performed by the information processing apparatus 50 according to the fifth example embodiment will be described. FIG. 10 is a diagram illustrating a flow of the information processing operation performed by the information processing apparatus 50 according to the fifth example embodiment.

As illustrated in FIG. 10, the image acquisition unit 215 acquires an image of the authentication subject wearing a wearable device D5 (step S20).

The biometric information acquisition unit 212 acquires the face image as the biometric information from the image acquired in the step S20 (step S32). The first matching unit 2111 performs the face authentication for the authentication subject using the face image of the authentication subject acquired in the step S32 (step S33).

The second matching unit 2112 detects the in-image wearing item identification information presented by the wearable device D5 and capable of uniquely identifying the wearable device D5 captured in the image acquired in the step S20 (step S34). The wearing item identification information acquisition unit 213 acquires the wearing item identification information capable of uniquely identifying the wearable device D5, from the wearable device D5 worn by the authentication subject (step S24). The second matching unit 2112 performs the wearing item matching, as the second matching using the in-image wearing item information and the wearing item identification information (step S35).

The third matching unit 2113 detects a first pulse of the authentication subject, based on the image (step S50). The third matching unit 2113 may detect the first pulse of the authentication subject. based on the face image. The third matching unit 2113 may detect the first pulse of the authentication subject from a change in color of a skin surface of a face that is a biometric authentication part in the image.

The third matching unit 2113 acquires a second pulse of the authentication subject, detected by the wearable device D5 from the authentication subject (step S51). The wearable device D5 may transmit information indicating the second pulse to the information processing apparatus 50, by presenting information capable of appearing in the image, such as light emission of blinking light of a LED or the like, or by transmitting a radio wave signal. Alternatively, the device reading apparatus 300 may read the second pulse detected by the wearable device D5, and the third matching unit 2113 may acquire the second pulse of the authentication subject from the device reading apparatus 300.

The third matching unit 2113 performs pulse verification, as the third matching using the first pulse and the second pulse (step S52). The third matching unit 2113 may verify matching of timing between the first pulse and the second pulse, or the like.

The association unit 211 determines whether or not all the face authentication, the pulse verification, and the third matching are successful (step S29). When all the matchings are successful (the step S29: Yes), the association unit 211 associates the authentication subject with the wearable device D5 worn by the authentication subject, based on the face authentication performed by the first authentication unit 2111, the wearing item matching performed by the second matching unit 2112, and the pulse verification performed by the third matching unit 2113 (step S30). When the association unit 211 associates the authentication subject with the wearable device D5, the authentication unit 216 authenticates the authentication subject by using the wearing item identification information (step S31).

### [5-2: Technical Effect of Information Processing System S5]

The information processing system S5 according to the fifth example embodiment is capable of verifying that a person performing the biometric authentication and a person wearing the wearing the device D5 are the same person, based on the pulse verification using the first pulse and the second pulse.

### 6: Sixth Example Embodiment

An information processing apparatus, a wearable device, an information processing method, and a recording medium according to a sixth example embodiment will be described. The following describes the information processing apparatus, the wearable device, the information processing method, and the recording medium according to the sixth example embodiment, by using an information processing system S6 to which the information processing apparatus, the wearable device, the information processing method, and the recording medium according to the sixth example embodiment are applied.

### [6-1: Overall Configuration of Information Processing System S6]

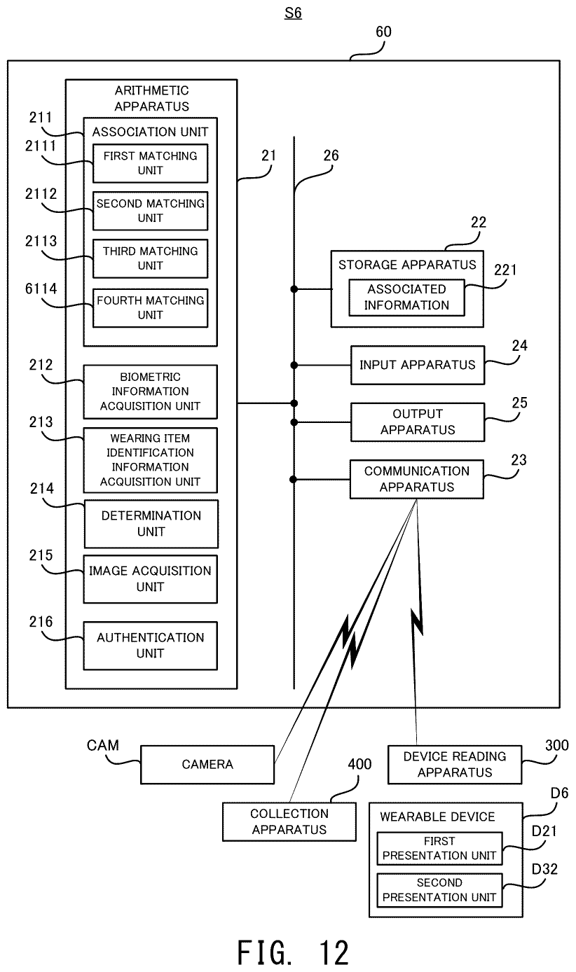

FIG. 11 is a conceptual diagram illustrating the information processing system S6 according to the sixth example embodiment. As illustrated in FIG. 11, the information processing system S6 according to the sixth example embodiment may include a collection apparatus 400 in addition to an information processing apparatus 60, a wearable device D6, the device reading apparatus 300, and the camera CAM. The collection apparatus 400 acquires fingerprint information as the biometric information. The information processing apparatus 60 may acquire an image from the camera CAM, may acquire the wearing item identification information from the device reading apparatus 300, may acquire the fingerprint information from the collection apparatus 400 and collection apparatus identification information capable of uniquely identifying the collection apparatus 400, and may associate the authentication subject with the wearable device D6.

[6-2: Configuration of Information processing Apparatus 60]

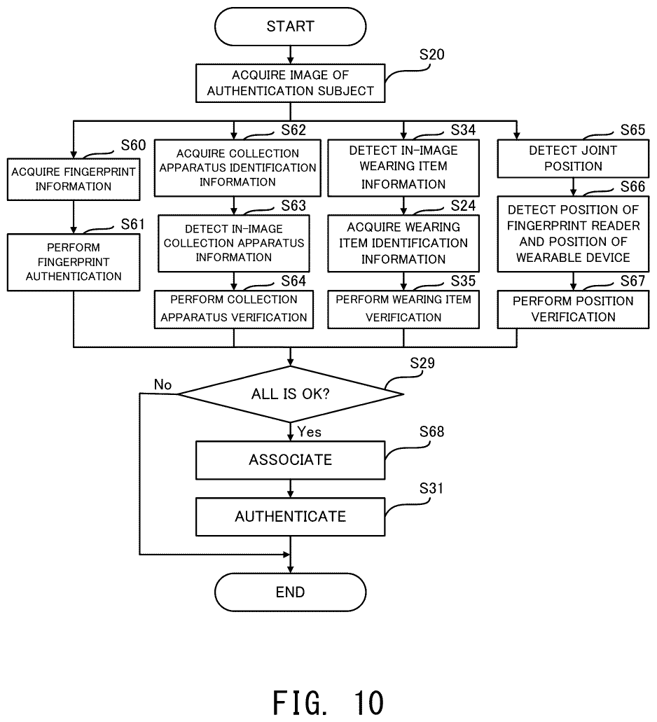

With reference to FIG. 12, a configuration of the information processing apparatus 60 according to the sixth example embodiment will be described. FIG. 12 is a block diagram illustrating the configuration of the information processing apparatus 60 according to the sixth example embodiment.

As illustrated in FIG. 12, the information processing apparatus 60 according to the sixth example embodiment includes the arithmetic apparatus 21 and the storage apparatus 22, as in the information processing apparatus 20 according to the second example embodiment to the information processing apparatus 50 according to the fifth example embodiment. Furthermore, the information processing apparatus 60 may include the communication apparatus 23, the input apparatus 24, and the output apparatus 25, as in the information processing apparatus 20 to the information processing apparatus 50. The information processing apparatus 60, however, may not include at least one of the communication apparatus 23, the input apparatus 24, and the output apparatus 25. The information processing apparatus 60 according to the sixth example embodiment is different from the information processing apparatus 20 according to the second example embodiment to the information processing apparatus 50 according to the fifth example embodiment in that the corresponding unit 211 provided in the arithmetic apparatus 21 further includes a fourth matching unit 6114. Other features of the information processing apparatus 60 may be the same as those of at least one of the information processing apparatus 20 to the information processing apparatus 50. For this reason, a part that is different from each of the example embodiments described above will be described in detail below, and a description of the other overlapping parts will be omitted as appropriate.

### [6-3: Information Processing Operation Performed by Information Processing Apparatus 60]

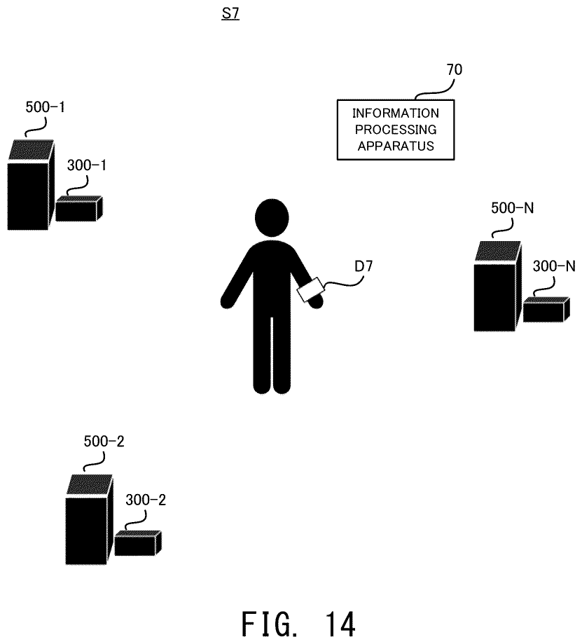

Next, with reference to FIG. 13, an information processing operation performed by the information processing apparatus 60 according to the sixth example embodiment will be described. FIG. 13 is a diagram illustrating a flow of the information processing operation performed by the information processing apparatus 60 according to the sixth example embodiment.

As illustrated in FIG. 13, the image acquisition unit 215 acquires an image of the authentication subject wearing the wearable device D6 (step S20).

The biometric information acquisition unit 212 acquires the fingerprint information, from the collection apparatus 400 that collects the fingerprint information as the biometric information (step S60). The collection apparatus 400 may be a fingerprint reader. The first matching unit 2111 performs fingerprint authentication (step S61).

The biometric information acquisition unit 212 acquires collection apparatus identification information capable of uniquely identifying the collection apparatus 400, from the collection apparatus 400 that collects the fingerprint information (step S62). The step S60 and the step S62 may be performed simultaneously.

The fourth matching unit 6114 detects in-image collection apparatus information presented by the collection apparatus, capable of uniquely identifying the collection apparatus 400, and capable of appearing in the image (step S63). The collection apparatus 400 may present a unique ID of the collection apparatus 400, in a manner capable of appearing in the image, such as light, characters, a one-dimensional code like a bar code, and a matrix-type two-dimensional code.

The fourth matching unit 6114 performs collection apparatus matching, as fourth matching using the collection apparatus identification information acquired in the step S62 and the in-image collection apparatus information detected in the step S63 (step S64).

The second matching unit 2112 detects the in-image wearing item identification information presented by the wearable device D6 and capable of uniquely identifying the wearable device D6 captured in the image acquired in the step S20 (step S34). The wearing item identification information acquisition unit 213 acquires the wearing item identification information capable of uniquely identifying the wearable device D6, from the wearable device D6 worn by the authentication subject (step S24). The second matching unit 2112 performs the wearing item matching, as the second matching using the in-image wearing item information and the wearing item identification information (step S35).

The third matching unit 2113 detects the joint position information indicating the position of the joint of the authentication subject included in the image (step S65). The third matching unit 2113 detects information indicating a position of the collection apparatus 400 included in the image and the wearing position information indicating a wearing position of the wearable device D6, of the authentication subject included in the image (step S66). The position of the collection apparatus 400 included in the image may be a position of the in-image wearing item identification information presented by the collection apparatus 400 detected in the step S63.

The third matching unit 2113 performs the position verification using the joint position information, the information indicating the position of the collection apparatus 400, and the wearing position information (step S67).

The association unit 211 determines whether or not all the fingerprint authentication, the collection apparatus matching, the wearing item matching, and the position verification are successful (step S29). When all the matchings are successful (the step S29: Yes), the association unit 211 associates the authentication subject with the wearable device D6 worn by the authentication subject, based on the fingerprint authentication performed by the first matching unit 2111, the wearing item matching performed by the second matching unit 2112, the position verification performed by the third matching unit 2113, and the collection apparatus matching performed by the fourth matching unit 6114 (step S68). That is, in the sixth example embodiment, the association unit 211 may associate a living body with the wearable device D6 worn by the living body, based on: the first matching by the first matching unit 2111; the second matching by the second matching unit 2112; the third matching by the third matching unit 2113; and the fourth matching by the fourth matching unit 6114 using the collection apparatus identification information, and the in-image collection apparatus information presented by the collection apparatus 400, capable of uniquely identifying the collection apparatus 400, and capable of appearing in the image. When the association unit 211 associates the authentication subject with the wearable device D6, the authentication unit 216 authenticates the authentication subject by using the wearing item identification information (step S31).

In the sixth example embodiment, the fingerprint authentication using the fingerprint information is performed in the step S61, but instead of the fingerprint authentication, authentication other than authentication using features of the living body extracted from the image captured by the camera CAM, such as palmprint authentication, vein authentication, and otoacoustic or ear acoustic authentication, may be performed.

### [6-4: Technical Effect of Information Processing System S6]

The information processing system S6 according to the sixth example embodiment performs the association, based on the fourth matching by the fourth matching unit 6114 using the collection apparatus identification information, and the in-image collection apparatus information presented by the collection apparatus 400, capable of uniquely identifying the collection apparatus 400, and capable of appearing in the image, in addition to the first matching, the second matching, the third matching. It is therefore possible to associate the authentication subject with the wearable device D6, more certainly.

### 7: Seventh Example Embodiment

An information processing apparatus, a wearable device, an information processing method, and a recording medium according to a seventh example embodiment will be described. The following describes the information processing apparatus, the wearable device, the information processing method, and the recording medium according to the seventh example embodiment, by using an information processing system S7 to which the information processing apparatus, the wearable device, the information processing method, and the recording medium according to the seventh example embodiment are applied.

### [7-1: Overall Configuration of Information Processing System S7]

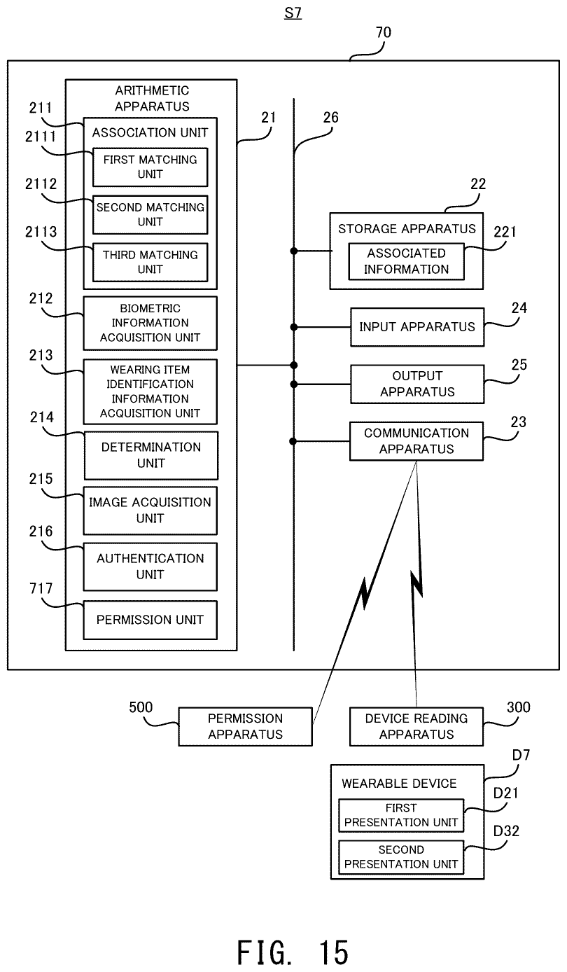

FIG. 14 is a conceptual diagram illustrating the information processing system S7 according to the seventh example embodiment. As illustrated in FIG. 14, the information processing system S7 according to the seventh example embodiment may include an information processing apparatus 70, a wearable device D7, each of a device reading apparatus 300-1, a device reading apparatus 300-2, and a device reading apparatus 300-N (hereinafter referred to as “device reading apparatus(es) 300” in some cases), each of a permission apparatus 500-1, a permission apparatus 500-2, and a permission apparatus 500-N (hereinafter referred to as a “permission apparatus(es) 500” in some cases). The permission apparatus 500 may be an apparatus that gives at least one of permission for the authentication subject to enter or exit a specific area and permission for the authentication subject to use a specific service. In the seventh example embodiment, each of the device reading apparatuses 300 may be provided in association with respective one of the permission apparatuses 500. FIG. 14 exemplifies a case where the information processing system S7 includes the device reading apparatus 300-1 corresponding to the permission apparatus 500-1, the device reading apparatus 300-2 corresponding to the permission apparatus 500-2, and the device reading apparatus 300-N corresponding to the permission apparatus 500-N. The information processing apparatus 70 may acquire the wearing item identification information from the device reading apparatus 300 and may give an instruction to permit an operation to be performed by the permission apparatus 500. When approaching the permission apparatus 500 that provides the service or the like that the authentication subject wishes to use, the authentication subject may be authenticated by using the wearing item identification information and may be receive the service or the like.

### [7-2: Configuration of Information Processing Apparatus 70]

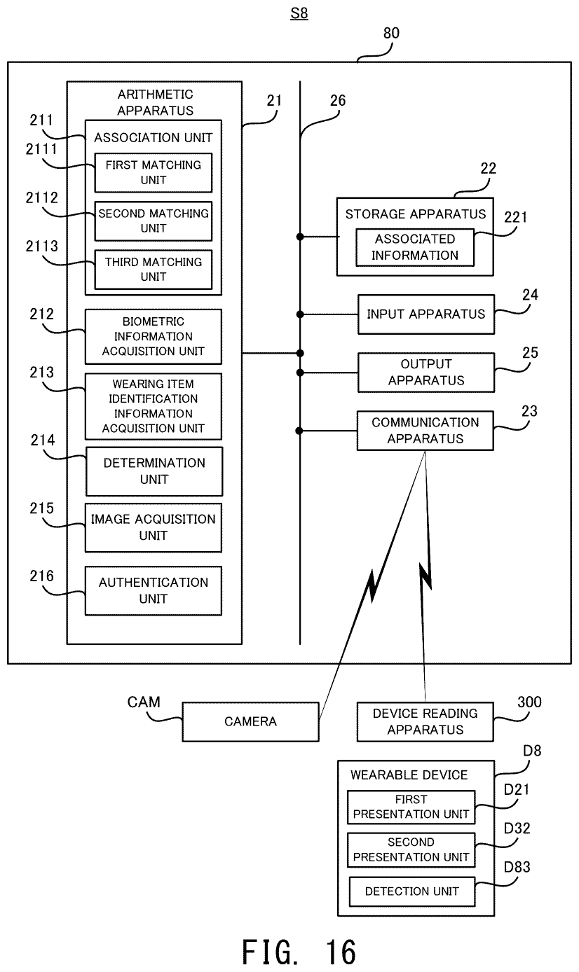

With reference to FIG. 15, a configuration of the information processing apparatus 70 according to the seventh example embodiment will be described. FIG. 15 is a block diagram illustrating the configuration of the information processing apparatus 70 according to the seventh example embodiment.

As illustrated in FIG. 15, the information processing apparatus 70 according to the seventh example embodiment includes the arithmetic apparatus 21 and the storage apparatus 22, as in the information processing apparatus 20 according to the second example embodiment to the information processing apparatus 60 according to the sixth example embodiment. Furthermore, the information processing apparatus 70 may include the communication apparatus 23, the input apparatus 24, and the output apparatus 25, as in the information processing apparatus 20 to the information processing apparatus 60. The information processing apparatus 70, however, may not include at least one of the communication apparatus 23, the input apparatus 24, and the output apparatus 25. The information processing apparatus 70 according to the seventh example embodiment is different from the information processing apparatus 20 according to the second example embodiment to the information processing apparatus 60 according to the sixth example embodiment in that the calculation apparatus 21 includes a permission unit 717. The permission unit 717 may give a living body wearing the wearable device D7 at least one of permission to enter or exit a specific area and permission to use a specific service. Other features of the information processing apparatus 70 may be the same as those of at least one of the information processing apparatus 20 to the information processing apparatus 60. For this reason, a part that is different from each of the example embodiments described above will be described in detail below, and a description of the other overlapping parts will be omitted as appropriate.

[7-3: Operation Performed in Information processing System S7]

For example, the permission apparatus 500-1 may be an apparatus that unlocks a door provided at an entrance of a specific area. The device reading apparatus 300-1 reads the wearing item identification information from the wearable device D7 worn by the authentication subject approaching the entrance of the specific area. The device reading apparatus 300-1 transmits the wearing item identification information to the information processing apparatus 70. The authentication unit 216 authenticates the authentication subject by using the wearing item identification information. The permission unit 717 determines whether to give permission to enter or exit the specific area to the authenticated authentication subject. When the permission unit 717 determines to give permission to enter or exit the specific area to the authentication subject, the permission unit 717 instructs the permission apparatus 500-1 to permit an operation of unlocking the door. The permission apparatus 500-1 unlocks the door provided at the entrance of the specific area, and the authentication subject is allowed to enter and exit the specific area.

In addition, for example, the permission apparatus 500-2 may be an apparatus used for specific services. The apparatus used for specific services may be an apparatus for using services including functions and information. The service may be a function, information, or the like that is available only to an authorized person. The device reading apparatus 300-2 reads the wearing item identification information from the wearable device D7 worn by the authentication subject approaching the permission apparatus 500-2. The device reading apparatus 300-2 transmits the wearing item identification information to the information processing apparatus 70. The authentication unit 216 authenticates the authentication subject by using the wearing item identification information. The permission unit 717 determines whether to give permission to log in the permission apparatus 500-2 to the authenticated authentication subject. When the permission unit 717 determines to give permission to log in the permission apparatus 500-2 to the authentication subject, the permission unit 717 instructs the permission apparatus 500-2 to permit the login. The permission unit 717 determines which of services provided by the permission apparatus 500-2 the authenticated authentication subject is permitted to use. The permission unit 717 instructs the permission apparatus 500-2 to permit the use of the service regarding which it is determined that the authentication subject is permitted to use. The authentication subject is allowed to log in the permission apparatus 500-2 and to use the specific service.

Furthermore, for example, the permission apparatus 500-N may be an apparatus that unlocks any of a plurality of drawers provided in a particular cabinet. The device reading apparatus 300-N reads the wearing item identification information from the wearable device D7 worn by the authentication subject approaching the particular cabinet. The device reading apparatus 300-N transmits the wearing item identification information to the information processing apparatus 70. The authentication unit 216 authenticates the authentication subject by using the wearing item identification information. The permission unit 717 determines whether to give permission to open or close any of the drawers to the authenticated authentication subject. When the permission unit 717 determines to give permission to open or close any of the drawers to the authenticated authentication subject, the permission unit 717 instructs the permission apparatus 500-N to permit an operation of unlocking the drawer regarding which it is determined that opening/closing permission is to be given. The permission apparatus 500-N unlocks the drawer regarding which it is determined that opening/closing permission is to be given, and the authentication subject is allowed to open or close the drawer regarding which it is determined that opening/closing permission is to be given.

The information processing apparatus 70 may authorize the use of the service regarding which the authentication subject is permitted, by using the authentication based on the wearing item identification information presented by the wearable device D7, while the authentication subject is wearing the wearable device D7. Furthermore, the information processing apparatus 70 may manage actions of the authentication subject, based on the wearing item identification information acquired from the plurality of device reading apparatuses 300.

### [7-4: Technical Effect of Information Processing System S7]

The information processing system S7 according to the seventh example embodiment is capable of providing personal authentication having the same accuracy as that of the accurate biometric authentication without reducing business the productivity. The information processing system S7 is based on a concept of Single Sign On. In a case where identity authentication is performed by the biometric authentication only once at the beginning, it is thereafter possible to authorize the use of various services by the authentication using the wearing item identification information corresponding to the authentication subject.

### 8: Eighth Example Embodiment

An information processing apparatus, a wearable device, an information processing method, and a recording medium according to an eighth example embodiment will be described. The following describes the information processing apparatus, the wearable device, the information processing method, and the recording medium according to the eighth example embodiment, by using an information processing system S8 to which the information processing apparatus, the wearable device, the information processing method, and the recording medium according to the eighth example embodiment are applied.

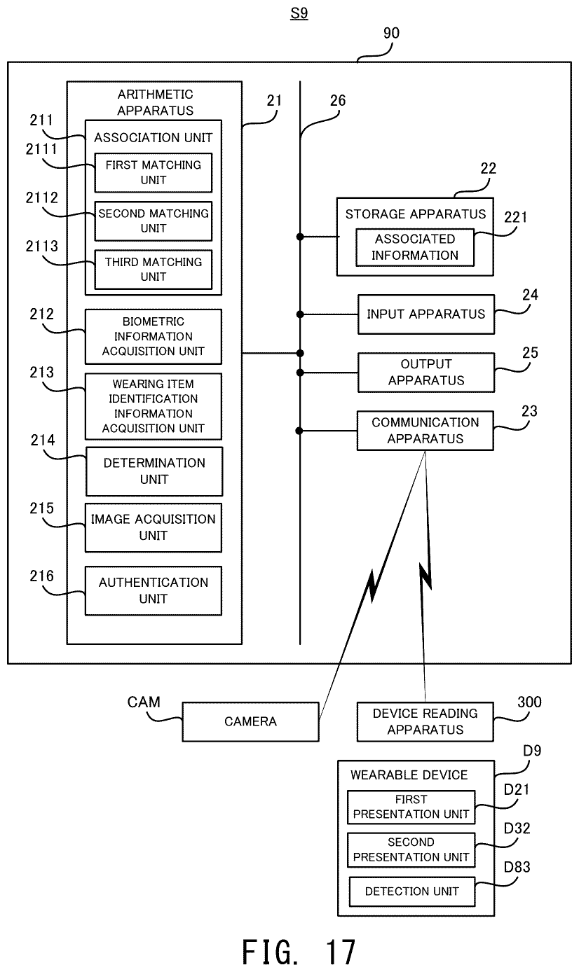

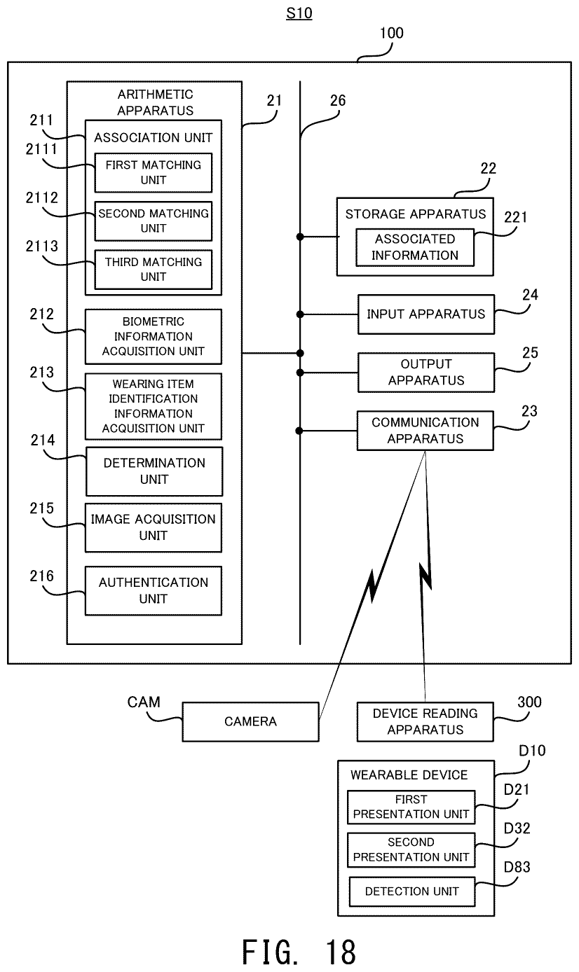

With reference to FIG. 16, a configuration of the information processing system S8 according to the eighth example embodiment will be described. FIG. 16 is a block diagram illustrating the configuration of the information processing system S8 according to the eighth example embodiment.

As illustrated in FIG. 16, the information processing system S8 according to the eighth example embodiment is different from the information processing system S2 according to the second example embodiment to the information processing system S7 according to the seventh example embodiment in that a wearable device D8 further includes a detection unit D83. The detection unit D83 detects that the wearable device D8 is removed from a living body. Other features of the information processing system S8 may be the same as those of at least one of the information processing system S2 to the information processing system S7. For this reason, a part that is different from each of the example embodiments described above will be described in detail below, and a description of the other overlapping parts will be omitted as appropriate.

### [8-1: Wearable Device D8]

The first presentation unit D21 presents the wearing item identification information capable of uniquely identifying the wearable device D8 when the wearable device D8 is worn by a living body. The device reading apparatus 300 may write the wearing item identification information on an electronic circuit of the wearable device D8 when the wearable device D8 is worn by the living body.

The wearable device D8 is removed from the living body when subjected to a specific operation. The specific operation may be unlocking or destruction of the wearable device D8 when the wearable device D8 is locked and worn. The detection unit D83 detects that the wearable device D8 is removed from the living body. The detection unit D83 may have an electrical contact for detecting the removal from the living body by unlocking or destruction.

When the detection unit D83 detects that the wearable device D8 is removed from the living body, the first presentation unit D21 ends the presentation of the wearing item identification information. For example, in a case where the wearable device D8 includes an active RF tag, the first presentation unit D21 may disable the wearing item identification information written in the electronic circuit. The wearable device D8 may have a function of ensuring that the association of the living body with the wearable device D8 is disabled, when removed by unlocking or destruction.

When the wearable device D8 is worn again by the living body, the first presentation unit D21 may present new identification information that is different from the wearing item identification information. That is, the wearable device D8 may have a function of ensuring that the wearing item identification information before unlocking or destruction cannot be reproduced, even if a third party wears again the wearable device D8. When the wearable device D8 is removed from the living body, the presentation of the wearing item identification information is ended, and the same wearing item identification information is not presented even if it is worn again. It is therefore possible to ensure the identity of the wearable device D8 when it is worn.

For example, the wearable device D8 may be a paper disposable wristband including a passive RF tag. In this case, at least a part of the electronic circuit of the wearable device D8 may be located throughout the wristband. In this case, when the wristband is torn and removed from a wrist, at least a part of the electronic circuit is disconnected, so that the wearable device D8 permanently loses its function of presenting the wearing item identification information. That is, in this case, the wearable device D8 is not allowed to end the presentation of the wearing item identification information and to be worn again when removed from the living body.

### [8-2: Information Processing Apparatus 80]

The association unit 211 disables the association of the living body with the wearable device D8 when the wearable device D8 is removed from the living body. When the detection unit D83 detects that the wearable device D8 is removed from the living body, the detection unit D83 may present removal information indicating the removal to an information processing apparatus 80 via the device reading apparatus 300. When the association unit 211 acquires the removal information from the wearable device D8, the association unit 211 may set corresponding information registered in the associated information 221 to be invalid information. In this case, for example, when the wearing item identification information acquisition unit 213 acquires the same identification information as the wearing item identification information on the wearable device D8 worn by the living body in the past, the identification information may not be associated with the living body wearing the wearable device D8 in the past.

When the wearable device D8 is worn again by the living body, the association unit 211 newly associates the living body with the wearable device D8. For example, the device reading apparatus 300 may write a new piece of the wearing item identification information onto the electronic circuit of the wearable device D8 when the wearable device D8 is worn again by the living body.

That is, the association of the living body with the wearable device D8 is valid while the living body is wearing the wearable device D8.

### [8-3: Technical Effect of Information Processing System S8]

The information processing system S8 according to the eighth example embodiment is capable of enabling the association of the living body with the wearable device D8, from when the living body puts on the wearable device D8 to when the living body takes off the wearable device S8.

### 9: Ninth Example Embodiment

An information processing apparatus, a wearable device, an information processing method, and a recording medium according to a ninth example embodiment will be described. The following describes the information processing apparatus, the wearable device, the information processing method, and the recording medium according to the ninth example embodiment, by using an information processing system S9 to which the information processing apparatus, the wearable device, the information processing method, and the recording medium according to the ninth example embodiment are applied.

A wearable device D9 has a structure corresponding to an uneven shape of a living body. The wearable device D9 may have a mechanical structure that uses the shape of the uneven shape of the living body and that is hardly removed from the living body while it is not unlocked, destroyed, or the like, such as handcuffs, a collar, and leg bands. Thus, when the wearable device D9 is worn by the living body, the state of the wearable device D9 being worn by the living body is maintained until it is subjected to a particular operation such as unlocking and destruction. An ID device with a special structure as in the wearable device D9 may be referred to as an “ID handcuff”

### [Technical Effect of Information Processing System S9]

The information processing system S9 according to the ninth example embodiment is capable of ensuring integrity/unity of the living body and the wearable device D9, in addition to ensuring the identity of the wearable device described in the example embodiments described above.

By adding an ID unique to personal belongings, to the personal belongings, it is possible to ensure a characteristic property of the personal belongings, at least in a range of amount of information that the ID can express. The characteristic property of the personal belongings may also greatly exceed a characteristic property of the biometric authentication. It is also possible to perform identity authentication while an owner of the personal belongings is working without giving any burden to the owner. It is possible to make a worker carry the wearable device D9 that presents the ID, which is differing for each device, and to track actions of the worker. On the other hand, the personal belongings may be held by a person other than the owner, and is hardly a substitute for the accurate biometric authentication in many cases.

In contrast, the wearable device D9 used in the information processing system S9 in the ninth example embodiment is worn by the living body and is integrated with the living body. Therefore, spoofing/impersonation using the wearable device D9 is hardly possible. Since the integrity/unity is ensured for the wearable device D9, “ensuring the characteristic property” and “ensuring authenticity” are possible, as in the biometric authentication. Furthermore, there is no risk of transfer to a third party, loss, or theft due to the integrity/unity. In addition, there is no biometric authentication issue that is a burden on the living body.

### 10: Tenth Example Embodiment

An information processing apparatus, a wearable device, an information processing method, and a recording medium according to a tenth example embodiment will be described. The following describes the information processing apparatus, the wearable device, the information processing method, and the recording medium according to the tenth example embodiment, by using an information processing system S10 to which the information processing apparatus, the wearable device, the information processing method, and the recording medium according to the tenth example embodiment are applied.

The information processing system S10 according to the tenth example embodiment is different from the information processing system S3 according to the third example embodiment to the information processing system S9 according to the ninth example embodiment, in the in-image wearing item identification information presented by the second presentation unit D32. Other features of the information processing system S10 may be the same as those of at least of the information processing system S3 to the information processing system S9. For this reason, a part that is different from each of the example embodiments described above will be described in detail below, and a description of the other overlapping parts will be omitted as appropriate.

In the tenth example embodiment, the in-image wearing item identification information may be information indicating a hash value based on at least identification information capable of uniquely identifying a wearable device D10 and based on confidential information known only by the wearable device D10 and a device that authenticates the wearable device D10. The in-image wearing item identification information may be information indicating a hash value based on the identification information capable of uniquely identifying the wearable device D10, based on the confidential information known only by the wearable device D10 and the device that authenticates the wearable device D10, and based on a time point when the wearable device D10 presents the in-image wearing item identification information. The device that authenticates the wearable device D10, and based on a time point when the wearable device D10 may be any one of the information processing apparatus 30 to the information processing apparatus 90.

### [Technical Effect of Information Processing System S10]

In the information processing system S10 according to the tenth example embodiment, the in-image wearing item identification information is information that cannot be generated by a third party who does not know the confidential information, and it is thus possible to improve verification accuracy. In addition, information used to verify the association with the biometric authentication changes from moment to moment. Thus, by including information about the time point in the in-image wearing item identification information, the information is more hardly generated by a third party, and it is thus possible to improve the verification accuracy.

### [11: Supplementary Notes]

With respect to the example embodiment described above, the following Supplementary Notes are further disclosed.

### [Supplementary Note 1]

An information processing apparatus including:
an association unit that associates a living body with a wearing item worn by the living body;
a biometric information acquisition unit that acquires biometric information collected from the living body;
a wearing item identification information acquiring unit that acquires wearing item identification information capable of uniquely identifying the wearing item, from the wearing item worn by the living body; and
a determination unit that determines whether the living body is wearing the wearing item associated with the living body by the association unit, based on the biometric information and the wearing item identification information.

### [Supplementary Note 2]

The information processing apparatus according to Supplementary Note 1, further including an image acquisition unit that acquires an image of the living body wearing the wearing item, wherein
the association unit associates the living body with the wearing item worn by the living body, based on:
first matching using the biometric information;
second matching using the wearing item identification information, and in-image wearing item information about the wearing item included in the image; and
third matching using in-image bio-related information about the living body included in the image, and wearing item bio-related information about the wearing item worn by the living body, and
the association unit further includes an authentication unit that authenticates the living body by using the wearing item identification information, in response to the association unit associating the living body with the wearing item.

### [Supplementary Note 3]

The information processing apparatus according to Supplementary Note 1 or 2, wherein the association unit associates the biometric information collected from the living body with the wearing item identification information capable of uniquely identifying the wearing item.

### [Supplementary Note 4]

The information processing apparatus according to Supplementary Note 2, wherein
the in-image wearing item information is in-image wearing item identification information presented by the wearing item, capable of uniquely identifying the wearing item, and capable of appearing in the image, and
the second matching is matching using the in-image wearing item identification information and the wearing item identification information.

### [Supplementary Note 5]

The information processing apparatus according to Supplementary Note 2, wherein
the in-image bio-related information includes: joint position information indicating a position of a joint of the living body included in the image; and collection position information indicating a position of collection of the biometric information, of the living body included in the image,
the wearing item bio-related information includes wearing position information indicating a wearing position of the wearing item, of the living body included in the image, and
the third matching is matching using the joint position information, the collection position information, and the wearing position information.

### [Supplementary Note 6]

The information processing apparatus according to Supplementary Note 2, wherein
the in-image bio-related information is a first pulse of the living body detected based on the image,
the wearing item bio-related information is a second pulse of the living body detected by the wearing item, and
the third matching is matching using the first pulse and the second pulse.

### [Supplementary Note 7]

The information processing apparatus according to Supplementary Note 2, wherein
the biometric information acquiring unit acquires, from a collection apparatus that collects the biometric information, the biometric information and collection apparatus identification information capable of uniquely identifying the collection apparatus, and
the association unit associates the living body with the wearing item worn by the living body, based on: the first matching; the second matching; the third matching; and fourth matching using the collection apparatus identification information, and in-image collection apparatus information presented by the collection apparatus, capable of uniquely identifying the collection apparatus, and capable of appearing in the image.

### [Supplementary Note 8]

The information processing apparatus according to Supplementary Note 1 or 2, wherein
the wearing item has a structure corresponding to an uneven shape of the living body, and
in response to the wearing item being worn by the living body, a state of the wearing item being worn by the living body is maintained until it is subjected to a particular operation.

### [Supplementary Note 9]

The information processing apparatus according to Supplementary Note 1 or 2, wherein
the wearing item is removed from the living body in response to being subjected to a particular operation,
the association unit disables association of the living body with the wearing item in response to the wearing item being removed from the living body, and
the association unit newly associates the living body with the wearing item in response to the wearing item being worn again by the living body.

### [Supplementary Note 10]

The information processing apparatus according to Supplementary Note 1 or 2, further including a permission unit that receives presentation of the wearing item identification information capable of uniquely identifying the wearing item, which is acquired from the wearing item, and gives at least one of permission to enter or exit a specific area and permission to use a specific service, to the living body wearing the wearing item.

### [Supplementary Note 11]

A wearable device to be worn by a living body, including:
a detection unit that detects that the wearable device is removed from the living body; and
a first presentation unit that
presents first identification information capable of uniquely identifying the wearable device in response to the wearable device being worn by the living body,
ends presentation of the first identification information in response to a detection that the wearable device is removed from the living body, and
presents new identification information that is different from the first identification information in response to the wearable device being worn again by the living body.

### [Supplementary Note 12]

The wearable device according to Supplementary Note 11, further including a second presentation unit that presents second identification information capable of uniquely identifying the wearable device and capable of appearing in an image.

### [Supplementary Note 13]

The wearable device according to Supplementary Note 11 or 12, wherein
the wearable device has a structure corresponding to an uneven shape of living body, and
in response to the wearable device being worn by the living body, a state of the wearable device being worn by the living body is maintained until it is subjected to a particular operation.

### [Supplementary Note 14]

The wearable device according to Supplementary Note 12, wherein the second identification information is information indicating a hash value based on identification information capable of uniquely identifying the wearable device and based on confidential information known only by the wearable device and a device that authenticates the wearable device.

### [Supplementary Note 15]

The wearable device according to Supplementary Note 12, wherein the second identification information is information indicating a hash value based on identification information capable of uniquely identifying the wearable device, based on confidential information known only by the wearable device and a device that authenticates the wearable device, and based on a time point of the second presentation unit presenting the second identification information.

[supplementary Note 16]

An information processing method including:
associating a living body with a wearing item worn by the living body;
acquiring biometric information collected from the living body;
acquiring wearing item identification information capable of uniquely identifying the wearing item, from the wearing item worn by the living body; and
determining whether the living body is wearing the wearing item associated with the living body, based on the biometric information and the wearing item identification information.

### [Supplementary Note 17]

A recording medium on which a computer program that allows a computer to execute an information processing method is recorded, the information processing method including:
associating a living body with a wearing item worn by the living body;
acquiring biometric information collected from the living body;
acquiring wearing item identification information capable of uniquely identifying the wearing item, from the wearing item worn by the living body; and
determining whether the living body is wearing the wearing item associated with the living body, based on the biometric information and the wearing item identification information.

At least a part of the constituent components of each of the example embodiments described above can be combined with at least another part of the constituent components of each of the example embodiments described above, as appropriate. A part of the constituent components of each of the example embodiments described above may not be used. Furthermore, to the extent permitted by law, the disclosures of all documents (e.g., publications) cited in this disclosure above are incorporated into the description of this disclosure.

This disclosure is not limited to the examples described above. This disclosure is allowed to be changed, if desired, without departing from the essence or spirit of this disclosure which can be read from the claims and the entire identification. An information processing apparatus, a wearable device, an information processing method, and a recording medium with such changes are also intended to be within the technical scope of this disclosure.

### DESCRIPTION OF REFERENCE CODES

10, 20, 30, 40, 50, 60, 70, 80, 90, 100 Information processing apparatus
S2, S3, S4, S5, S6, S7, S8, S9, S10 Information processing system
11, 211 Association unit
12, 212 Biometric information acquisition unit
13, 213 Wearing item identification information acquisition unit
14, 214 Determination unit
215 Image acquisition unit
2111 First matching unit
2112 Second matching unit
2113 Third matching unit
6114 Fourth matching unit
216 Authentication unit
717 Permission unit
D2, D3, D4, D5, D6, D7, D8, D9, D10 Wearable device
D21 First presentation unit
D32 Second presentation unit
D83 Detection unit
300 Device reading apparatus
400 Collection apparatus
500 Permission apparatus
Camera CAM

What is claimed is:

1. An information processing apparatus comprising:
at least one memory that is configured to store instructions; and
at least one first processor that is configured to execute the instructions to:
associate a living body with a wearing item worn by the living body;
acquire biometric information collected from the living body;
acquire wearing item identification information capable of uniquely identifying the wearing item, from the wearing item worn by the living body; and
determine whether the living body is wearing the wearing item associated with the living body, based on the biometric information and the wearing item identification information.

2. The information processing apparatus according to claim 1, wherein the at least one first processor is configured to execute the instructions to:
acquire an image of the living body wearing the wearing item; and
associate the living body with the wearing item worn by the living body, based on:
first matching using the biometric information;
second matching using the wearing item identification information, and in-image wearing item information about the wearing item included in the image; and
third matching using in-image bio-related information about the living body included in the image, and wearing item bio-related information about the wearing item worn by the living body, and the at least one first processor is configured to execute the instructions to authenticate the living body by using the wearing item identification information, in response to association unit associating the living body with the wearing item.

3. The information processing apparatus according to claim 1, wherein the at least one first processor is configured to execute the instructions to associate the biometric information collected from the living body with the wearing item identification information capable of uniquely identifying the wearing item.

4. The information processing apparatus according to claim 2, wherein
the in-image wearing item information is in-image wearing item identification information presented by the wearing item, capable of uniquely identifying the wearing item, and capable of appearing in the image, and
the second matching is matching using the in-image wearing item identification information and the wearing item identification information.

5. The information processing apparatus according to claim 2, wherein
the in-image bio-related information includes: joint position information indicating a position of a joint of the living body included in the image; and collection position information indicating a position of collection of the biometric information, of the living body included in the image,
the wearing item bio-related information includes wearing position information indicating a wearing position of the wearing item, of the living body included in the image, and
the third matching is matching using the joint position information, the collection position information, and the wearing position information.

6. The information processing apparatus according to claim 2, wherein
the in-image bio-related information is a first pulse of the living body detected based on the image,
the wearing item bio-related information is a second pulse of the living body detected by the wearing item, and
the third matching is matching using the first pulse and the second pulse.

7. The information processing apparatus according to claim 2, wherein the at least one first processor is configured to execute the instructions to:
acquire, from a collection apparatus that collects the biometric information, the biometric information and collection apparatus identification information capable of uniquely identifying the collection apparatus, and
associate the living body with the wearing item worn by the living body, based on: the first matching; the second matching; the third matching; and fourth matching using the collection apparatus identification information, and in-image collection apparatus information presented by the collection apparatus, capable of uniquely identifying the collection apparatus, and capable of appearing in the image.

8. The information processing apparatus according to claim 1, wherein
the wearing item has a structure corresponding to an uneven shape of the living body, and
in response to the wearing item being worn by the living body, a state of the wearing item being worn by the living body is maintained until it is subjected to a particular operation.

9. The information processing apparatus according to claim 1, wherein
the wearing item is removed from the living body in response to being subjected to a particular operation,
the at least one first processor is configured to execute the instructions to disable association of the living body with the wearing item in response to the wearing item being removed from the living body, and
the at least one first processor is configured to execute the instructions to newly associate the living body with the wearing item in response to the wearing item being worn again by the living body.

10. The information processing apparatus according to claim 1, wherein the at least one first processor is configured to execute the instructions to: receive presentation of the wearing item identification information capable of uniquely identifying the wearing item, which is acquired from the wearing item; and give at least one of permission to enter or exit a specific area and permission to use a specific service, to the living body wearing the wearing item.

11-15. (canceled)

16. An information processing method comprising:
associating a living body with a wearing item worn by the living body;
acquiring biometric information collected from the living body;
acquiring wearing item identification information capable of uniquely identifying the wearing item, from the wearing item worn by the living body; and
determining whether the living body is wearing the wearing item associated with the living body, based on the biometric information and the wearing item identification information.

17. A non-transitory recording medium on which a computer program that allows a computer to execute an information processing method is recorded, the information processing method including:
associating a living body with a wearing item worn by the living body;
acquiring biometric information collected from the living body;
acquiring wearing item identification information capable of uniquely identifying the wearing item, from the wearing item worn by the living body; and
determining whether the living body is wearing the wearing item associated with the living body, based on the biometric information and the wearing item identification information.
